(19) United States
(12) Patent Application Publication
(10) Pub. No.: US 2025/0232631 A1
(43) Pub. Date: Jul. 17, 2025

(54) BANKNOTE HANDLING METHOD

(71) Applicant: Glory Ltd., Himeji-shi (JP)

(72) Inventor: Keisuke NADA, Himeji-shi (JP)

(73) Assignee: Glory Ltd., Himeji-shi (JP)

(21) Appl. No.: 19/013,029

(22) Filed: Jan. 8, 2025

(30) Foreign Application Priority Data
Jan. 16, 2024 (JP) 2024-004809

(51) Int. Cl. G07D 11/22; G07D 7/202; G07D 11/14; G07D 11/18

(52) U.S. Cl. CPC G07D 11/22; G07D 11/14; G07D 11/18; G07D 7/202; G07D 2207/00; G07D 2211/00

(57) ABSTRACT

A banknote handling method includes: sequentially feeding banknotes from an inlet to an inside of an apparatus; sequentially recognizing the banknotes fed to the inside of the apparatus using a recognition circuit; transporting a first banknote to a first storage for the first denomination by a conveyor and storing the first banknote in the first storage, wherein the recognition circuit recognizes that the first banknote is a banknote of the first denomination and has a first serial number; after recognizing the first banknote by the recognition circuit, transporting a second banknote to a second storage by the conveyor based on a comparison between the first serial number and the second serial number performed by a controller, wherein the recognition circuit recognizes that the second banknote is a banknote of the first denomination and has the second serial number.

### CROSS-REFERENCE TO RELATED APPLICATION

This application claims priority to Japanese Patent Application No. 2024-004809 filed on Jan. 16, 2024, the entire disclosure of which is incorporated herein by reference.

### BACKGROUND

If a user selects a deposit transaction, a conventional automated teller machine performs the depositing process. In the depositing process, the automated teller machine discriminates banknotes inserted into a depositing/dispensing unit using a discrimination unit. The discrimination unit discriminates banknotes and recognizes serial numbers. The automated teller machine returns banknotes including unrecognizable characters of which the number exceeds a predetermined threshold value to the depositing/dispensing unit as banknotes that cannot be deposited.

If a user selects a dispensing transaction, the automated teller machine performs the dispensing process. In the dispensing process, the automated teller machine discriminates banknotes fed out from a recycle box using the discrimination unit. The discrimination unit discriminates banknotes and recognizes serial numbers. The automated teller machine returns banknotes including unrecognizable characters the number of which exceeds the predetermined threshold value to a temporary storage unit as banknotes that cannot be dispensed.

Serial numbers of banknotes are used for various purposes in banknote handling. A conventional banknote handling machine performs a replenishing process. The replenishing process is a process of replenishing a banknote storage cassette with banknotes to be dispensed. In the replenishing process, the banknote handling machine stores banknotes inserted into a depositing/dispensing unit and recognized by a recognition unit in the banknote storage cassette. If a plurality of serial numbers sequentially recognized by the recognition unit in the replenishing process are consecutive, the banknote handling machine judges that the replenished banknotes are new series notes which are brand-new notes with a bind removed.

A banknote handling apparatus may use serial numbers of banknotes to manage the stored banknotes. A conventional banknote handling method for identifying the inventory amount in a storing unit uses serial numbers of banknotes. Specifically, in this conventional banknote handling method, a list in which serial numbers of banknotes stored in the storing unit are arranged in the sequence in which the banknotes are stored is stored. If a banknote is fed out from the storing unit, the serial number of the banknote fed out is read and is matched with the list, thereby identifying the banknotes stored in the storing unit after feeding.

### SUMMARY

The present disclosure relates to a banknote handling method. The banknote handling method includes:
sequentially feeding banknotes from an inlet to an inside of an apparatus;
sequentially recognizing the banknotes fed to the inside of the apparatus using a recognition circuit;
transporting a first banknote to a first storage for a first denomination by a conveyor and storing the first banknote in the first storage, wherein the recognition circuit recognizes that the first banknote is a banknote of the first denomination and has a first serial number; and
after recognizing the first banknote by the recognition circuit, transporting a second banknote to a second storage by the conveyor based on a comparison between the first serial number and a second serial number performed by a controller, wherein the recognition circuit recognizes that the second banknote is a banknote of the first denomination and has the second serial number.

### BRIEF DESCRIPTION OF THE DRAWINGS

FIG. 1 shows a banknote handling apparatus for a banknote handling method.

FIG. 2 is a block diagram of the banknote handling apparatus.

FIG. 3 shows a transport route of banknotes in the depositing process.

FIG. 4 shows a transport route of banknotes in the dispensing process.

FIG. 5 illustrates a matching process for serial numbers in the dispensing process.

FIG. 6 illustrates a matching process for serial numbers in the depositing process.

FIG. 7 is a flowchart of the depositing process.

FIG. 8 shows the banknote handling apparatus for the banknote handling method.

### DETAILED DESCRIPTION OF THE DRAWINGS

It is difficult for the recognition unit of the banknote handling apparatus to accurately read all characters of the serial number of each banknote. If all the characters being successfully recognized means the serial number being successfully recognized, the number of banknotes of which the serial numbers fail to be recognized is significantly increased. The conventional banknote handling apparatus permits failure to recognize some characters per serial number in order to avoid a reduction in the handling efficiency.

However, permitting failure to recognize some characters might lead to reduction in the accuracy of matching between the serial number recognized and the serial number stored. An example of this case is that similar serial numbers are matched together. The serial numbers being similar means that the number of characters that disagree among a plurality of serial numbers is less than or equal to a predetermined number. A plurality of consecutive serial numbers are similar. This is because the number of characters that disagree among the plurality of consecutive serial numbers is one or two. If failure to recognize some characters is permitted, the banknote handling apparatus judges that the recognized serial number and the stored serial number are identical even if matching of those serial numbers shows that some of the characters disagree. The banknote handling apparatus might judge that a plurality of similar serial numbers are all identical. The banknote handling apparatus is required to perform banknote handling which enables less reduction in the handling efficiency and less reduction in the matching accuracy of the serial numbers.

The present disclosure provides appropriate banknote handling that involves recognition of serial numbers.

The present disclosure relates to a banknote handling method. The banknote handling method includes:
sequentially feeding banknotes from a depositing unit to an inside of an apparatus;
sequentially recognizing the banknotes fed to the inside of the apparatus using a recognition unit;
transporting a first banknote to a first storing unit for a first denomination by a transport unit and storing the first banknote in the first storing unit, wherein the recognition unit recognizes that the first banknote is a banknote of the first denomination and has a first serial number; and
after recognizing the first banknote by the recognition unit, transporting a second banknote to a second storing unit by the transport unit based on a comparison between the first serial number and a second serial number performed by a control unit, wherein the recognition unit recognizes that the second banknote is a banknote of the first denomination and has the second serial number.

The banknote handling is a process for storing banknotes in the storing units, where those banknotes are sequentially fed from the depositing unit to the inside of the apparatus. The recognition unit sequentially recognizes the banknotes before the banknotes are stored in the storing units.

The first banknote, where the recognition unit recognizes that the first banknote is a banknote of a first denomination and has a first serial number, is transported to the first storing unit and is stored in the first storing unit. The first storing unit is a storing unit for the first denomination.

After the first banknote is recognized, the second banknote, where the recognition unit recognizes that the second banknote is a banknote of the first denomination and has a second serial number, is transported to the second storing unit by the transport unit based on a comparison between the first serial number and the second serial number. The second banknote is not stored in the first storing unit or not stored near the first banknote in the first storing unit. Separating the first banknote and the second banknote enables appropriate banknote handling.

The control unit may determine whether the first serial number and the second serial number are similar,
if the first serial number and the second serial number are similar, the second banknote may be transported to the second storing unit by the transport unit, and
if the first serial number and the second serial number are not similar, the second banknote may be transported to the first storing unit by the transport unit, and is stored in the first storing unit.

If the first serial number and the second serial number are similar, the first banknote and the second banknote are transported to different storing units. The first banknote and the second banknote are separated. If the first serial number and the second serial number are similar, appropriate banknote handling is achieved. If the first serial number and the second serial number are not similar, both the first banknote and the second banknote are transported to the first storing unit and stored in the first storing unit.

The control unit may determine that the first serial number and the second serial number are similar if matching the first serial number with the second serial number both recognized by the recognition unit shows that the number of characters that disagree therebetween is less than or equal to a predetermined number n.

That is, in the banknote handling, failure to recognize n characters per serial number may be permitted. Permitting failure to recognize n characters enables less reduction in the efficiency of banknote handling.

A memory unit may store a serial number of the banknote stored in the first storing unit,
in a dispensing process of the apparatus, the first storing unit may feed out a banknote stored in the first storing unit as a banknote for dispensing,
the recognition unit may recognize the banknote which the first storing unit feeds out in the dispensing process, and the control unit may match the serial number recognized with the stored serial number, and
the control unit may determine that the serial number recognized and the stored serial number are identical if the number of characters that disagree between the serial number recognized and the stored serial number is less than or equal to the predetermined number n.

In the dispensing process of the apparatus, when matching of the serial number of the recognized banknote fed out from the first storing unit with the stored serial number, the control unit determines that the recognized serial number and the stored serial number are identical, if the number of characters that disagree is less than or equal to the predetermined number n. Permitting disagreement on characters of which the number is less than or equal to the predetermined number n in matching of the serial numbers enables accurate management of the banknotes using the serial numbers without lowering the handling efficiency.

If the first serial number and the second serial number are similar, the second banknote is not stored in the first storing unit, or the second banknote is not stored near the first banknote in the first storing unit, as described above. Erroneous matching between the first banknote and the second banknote with similar serial numbers is reduced.

The predetermined number n may be changeable. It can be said that changing the predetermined number n means changing (or adjusting) the degree of similarity between the two serial numbers. The banknotes can be accurately managed using the serial numbers, or the handling efficiency can be improved, depending on the predetermined number n.

The predetermined number n may be set based on a recognition capability of the recognition unit. If the recognition capability of the recognition unit is high, the predetermined number n may be set small. The handling efficiency is not lowered, while accurate management of the banknotes using the serial numbers can be achieved. If the recognition capability of the recognition unit is low, the predetermined number n may be set large. The handling efficiency is less lowered, while accurate management of the banknotes using the serial numbers can be still achieved. The recognition unit may set the predetermined number n by itself based on the self-diagnosis, or the user may manually set the predetermined number n.

The control unit may compare the second serial number with each serial number, wherein a banknote corresponding to each serial number is included in a group consisting of continuous m banknotes immediately prior to the second banknote among banknotes recognized as banknotes of the first denomination and stored in the first storing unit before the second banknote is recognized by the recognition unit, and
if a serial number similar to the second serial number is included in the group, the transport unit may transport the second banknote to the second storing unit.

Here, when the serial number of the banknote fed out from the first storing unit is matched with the stored serial number in the dispensing process, the serial number of the banknote fed out from the first storing unit may be matched with the serial numbers of the m banknotes stored.

If the second banknote is stored in the first storing unit, a banknote with a serial number similar to that of the second banknote is not stored at least near the second banknote in the first storing unit. That is, banknotes with similar serial numbers are not stored close to each other in the first storing unit. In the dispensing process, matching of banknotes with similar serial numbers is reduced, and thus erroneous matching is reduced.

The number m of the banknotes may be changeable. The number m can be set to any number.

The first storing unit may store the banknotes in a stacked manner. The order in which banknotes are stored in a so-called “stack-type” storing unit may be different from the order in which banknotes are transported to the storing unit. Determining the destination of the second banknote based on a comparison between each of the serial numbers included in the group consisting of m banknotes and the second serial number reduces improper matching between the serial numbers, and enables accurate management of banknotes using the serial numbers, for the first storing unit where the banknotes are stored in a stacked manner.

In the dispensing process of the apparatus, the second storing unit may not feed out a banknote stored in the second storing unit as a banknote for dispensing.

Since the serial numbers of the banknotes stored in the second storing unit are not matched, erroneous matching can be avoided.

The first storing unit and the second storing unit may be housed in a safe. The apparatus can safely manage the banknotes stored in the first storing unit and the second storing unit.

The second storing unit may be a dispensing unit that dispenses the second banknote to an outside of the apparatus. That is, the second banknote may be returned to the user.

A notification may be made to propose reinserting the second banknote to the depositing unit, wherein the second banknote is a banknote having been dispensed to the dispensing unit, and
the second banknote may be transported to the first storing unit by the transport unit, and is stored in the first storing unit if the second serial number of the second banknote fed again from the depositing unit to the inside of the apparatus is not similar to serial numbers of m banknotes most recently stored in the first storing unit.

In a process of storing a plurality of banknotes inserted into the depositing unit in the storing unit, if the first banknote and the second banknote with similar serial numbers are recognized as consecutive, the second banknote is returned to the user. After the second banknote, the banknote, where the recognition unit recognizes that this banknote is a banknote of the first denomination, is stored continuously with the first banknote in the first storing unit.

If the returned second banknote is reinserted into the apparatus, banknotes other than the first banknote may be stored in the first storing unit. It is possible that the second serial number is not similar to the serial numbers of the m banknotes most recently stored in the first storing unit. Even if the reinserted second banknote is stored in the first storing unit, banknotes with similar serial numbers are not stored closer to each other in the first storing unit. Erroneous matching in the dispensing process is reduced.

The control unit may allocate the second banknote reinserted into the depositing unit to a transaction related to the banknote initially fed from the depositing unit to the inside of the apparatus.

Since the reinserted second banknote is managed as a banknote related to one transaction, the banknote handling becomes appropriate.

The control unit may decide transporting the second banknote to the first storing unit for the first denomination by the transport unit, wherein the recognition unit recognizes that the second banknote is a banknote of the first denomination and has the second serial number, and
then, changing a destination of the second banknote from the first storing unit to the second storing unit is decided based on the comparison between the first serial number and the second serial number performed by the control unit, whereby the second banknote is transported to the second storing unit by the transport unit.

An embodiment of a banknote handling method will be described below with reference to the drawings. A banknote handling method described herein is an example.

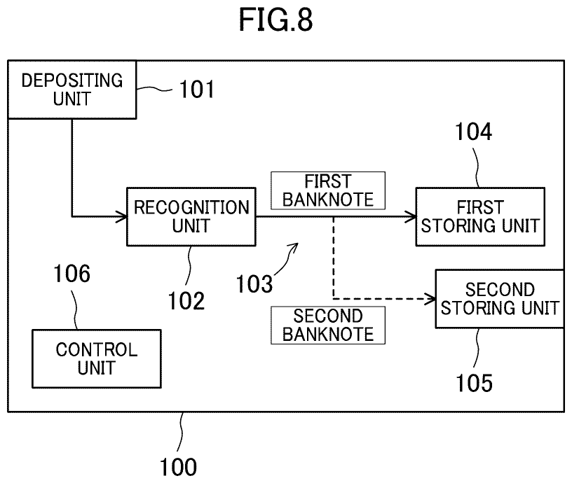

FIG. 8 shows a banknote handling apparatus 100 for the banknote handling method. The banknote handling apparatus 100 handles loose notes.

The banknote handling apparatus 100 includes a depositing unit 101. The depositing unit 101 sequentially feeds banknotes to the inside of the banknote handling apparatus 100, where those banknotes are to be stored in a first storing unit 104 of the banknote handling apparatus 100.

The banknote handling apparatus 100 includes a recognition unit 102. The recognition unit 102 sequentially recognizes the banknotes fed into the banknote handling apparatus 100. The recognition unit 102 recognizes at least the denomination of a banknote and the serial number of a banknote. The recognition unit 102 includes a sensor and a central processing unit (CPU) for recognizing at least the denomination of a banknote and the serial number of a banknote.

Here, the serial number is put on the banknote in order to identify the banknote, and consists of symbols such as numbers, letters, and marks; and equivalents of symbols. The serial number is not a random set of symbols but a sequential set of symbols. Thus, consecutive serial numbers may be put across a plurality of banknotes.

The banknote handling apparatus 100 includes a transport unit 103. The recognition unit 102 is adjacent to or incorporated in the transport unit 103. The transport unit 103 transports the banknotes recognized by the recognition unit 102 to the first storing unit 104 or a second storing unit 105.

The banknote handling apparatus 100 includes the first storing unit 104. The first storing unit 104 stores the banknotes. The banknote handling apparatus 100 includes the second storing unit 105. The second storing unit 105 holds the banknotes.

The banknote handling apparatus 100 includes a control unit 106. The control unit 106 controls the depositing unit 101, the recognition unit 102, the transport unit 103, the first storing unit 104, and the second storing unit 105.

The banknote handling method disclosed herein includes the following steps. The steps include:
sequentially feeding banknotes from the depositing unit 101 to the inside of the banknote handling apparatus 100;
sequentially recognizing the banknotes fed to the inside of the banknote handling apparatus 100 using the recognition unit 102;
transporting a first banknote, where the recognition unit 102 recognizes that the first banknote is a banknote of a first denomination and has a first serial number, to the first storing unit 104 for the first denomination through the transport unit 103, and storing the first banknote in the first storing unit 104, as indicated by the solid arrow in FIG. 8;
after recognizing the first banknote by the recognition unit 102, transporting a second banknote, where the recognition unit 102 recognizes that the second banknote is a banknote of the first denomination and has a second serial number, to the second storing unit 105 through the transport unit 103 based on a comparison between the first serial number and the second serial number performed by the control unit 106, as indicated by the dashed arrow in FIG. 8.

The second banknote is not stored in the first storing unit 104. Separating the first banknote and the second banknote enables appropriate banknote handling.

### (Structure of Banknote Handling Apparatus)

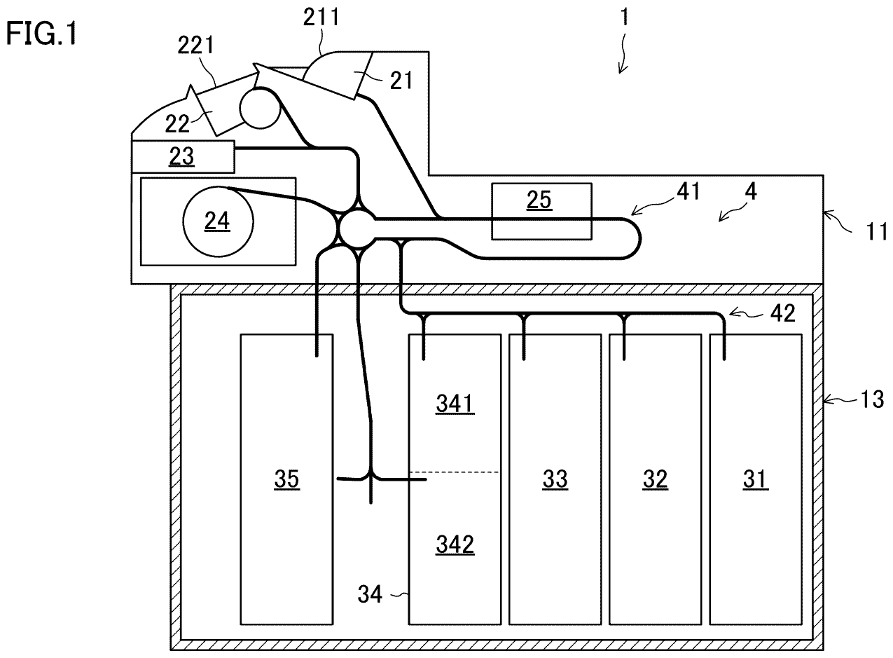

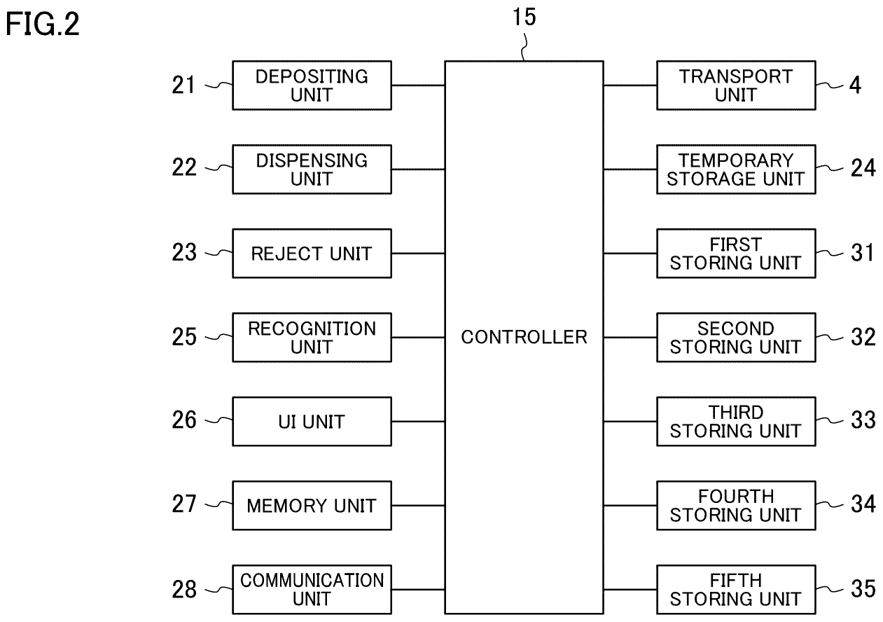

FIG. 1 shows the overall structure of the banknote handling apparatus for the banknote handling method. FIG. 2 is a block diagram of the banknote handling apparatus. The banknote handling apparatus 1 is a variation of the banknote handling apparatus 100. The banknote handling apparatus 1 performs at least a depositing process and a dispensing process of loose notes. If the user selects the deposit transaction, the banknote handling apparatus 1 performs the depositing process. The depositing process is a process of storing banknotes inserted into a depositing unit 21 described later in a storing unit 31, 32, 33, 34, or 35 provided in the apparatus. If the user selects a dispensing transaction, the banknote handling apparatus 1 performs the dispensing process. The dispensing process is a process of dispensing banknotes fed out from the storing unit 31, 32, 33, or 34 to a dispensing unit 22 described later.

The banknote handling apparatus 1 includes a handling housing 11 provided on the upper part and a safe housing 13 provided on the lower part. The safe housing 13 is made of a metal board with a thickness higher than or equal to a predetermined thickness. The security level of the safe housing 13 is higher than that of the handling housing 11.

The banknote handling apparatus 1 includes the depositing unit 21. The depositing unit 21 is located in the handling housing 11. The depositing unit 21 is a portion into which banknotes are inserted in the depositing process, for example. The depositing unit 21 includes an inlet 211. The user manually inserts (or places) banknotes into the depositing unit 21 through the inlet 211. The depositing unit 21 is capable of holding a plurality of stacked banknotes. The depositing unit 21 includes a mechanism that feeds out the banknotes into the banknote handling apparatus 1 one by one.

The banknote handling apparatus 1 includes the dispensing unit 22. The dispensing unit 22 is located in the handling housing 11. The dispensing unit 22 is a portion to which the banknotes fed out from the storing units 31, 32, 33, and 34 are transported in the dispensing process, for example. The dispensing unit 22 is capable of holding a plurality of stacked banknotes. The dispensing unit 22 includes an outlet 221. The user can manually pick up the banknotes stacked in the dispensing unit 22 through the outlet 221.

The banknote handling apparatus 1 includes a reject unit 23. The reject unit 23 is located in the handling housing 11. The reject unit 23 holds banknotes rejected in the dispensing process, for example.

The banknote handling apparatus 1 includes a temporary storage unit 24. The temporary storage unit 24 is located in the handling housing 11. The temporary storage unit 24 temporarily stores the banknotes deposited in the depositing process, for example. The temporary storage unit 24 can feed out the stored banknotes. The temporary storage unit 24 is a tape-winding storing unit. The temporary storage unit 24 stores the banknotes by wrapping them around a drum together with a tape. The tape-winding storing unit is advantageous in that the sequence of the banknotes does not switch between when they are stored and when they are fed out. Further the tape-winding storing unit is also advantageous in that it is capable of storing mixed banknotes of various sizes. The temporary storage unit 24 can employ a known structure of the tape-winding storing unit.

The banknote handling apparatus 1 includes a recognition unit 25. The recognition unit 25 is located in the handling housing 11. The recognition unit 25 is located on an upper transport unit 41 described later. The recognition unit 25 recognizes at least the currency, authentication, denomination, and fitness of every single banknote transported through the upper transport unit 41. The recognition unit 25 also recognizes a serial number printed on the banknote. The recognition unit 25 optically recognizes the serial number. Since a technique of recognizing the serial number is known, the detailed description is omitted. The recognition unit 25 can employ known various techniques, as appropriate.

The banknote handling apparatus 1 includes the first storing unit 31, the second storing unit 32, the third storing unit 33, the fourth storing unit 34, and the fifth storing unit 35. The first storing unit 31, the second storing unit 32, the third storing unit 33, the fourth storing unit 34, and the fifth storing unit 35 are housed in the safe housing 13.

The first storing unit 31, the second storing unit 32, the third storing unit 33, and the fifth storing unit 35 have the same structure. Each of the first storing unit 31, the second storing unit 32, the third storing unit 33, and the fifth storing unit 35 is a stack-type storing unit. The stack-type storing unit stores the banknotes stacked vertically. The stack-type storing unit stores a banknote (temporarily referred to as the “precedent banknote”), and then stores the subsequent banknote so that the subsequent banknote recognized after the preceding banknote is placed above the preceding banknote. Each of the first storing unit 31, the second storing unit 32, the third storing unit 33, and the fifth storing unit 35 includes a single storage region and a single transport mechanism. Each of the first storing unit 31, the second storing unit 32, the third storing unit 33, and the fifth storing unit 35 can store banknotes in the storage region and can feed out banknotes from the storage region. Each of the first storing unit 31, the second storing unit 32, the third storing unit 33, and the fifth storing unit 35 feeds out banknotes by a first-in last-out manner.

The fourth storing unit 34 is a stack-type storing unit. The fourth storing unit 34 includes a first storage region 341 and a second storage region 342. The first storage region 341 and the second storage region 342 are independent from each other. The fourth storing unit 34 includes a first transport mechanism for the first storage region 341 and a second transport mechanism for the second storage region 342. The fourth storing unit 34 can store banknotes in the first storage region 341 and feed out banknotes from the first storage region 341, and can store banknotes in the second storage region 342 and feed out banknotes from the second storage region 342. The fourth storing unit 34 also feeds out banknotes by a first-in last-out manner.

The first storing unit 31, the second storing unit 32, the third storing unit 33, and the first storage region 341 and the second storage region 342 of the fourth storing unit 34 store banknotes in the depositing process. The first storing unit 31, the second storing unit 32, the third storing unit 33, and the first storage region 341 and the second storage region 342 of the fourth storing unit 34 may store the banknotes of different denominations. Two or more of the storing units or the storage regions may store the banknotes of the same denomination. The first storing unit 31, the second storing unit 32, the third storing unit 33, and the first storage region 341 and the second storage region 342 of the fourth storing unit 34 feed out banknotes in the dispensing process. The first storing unit 31, the second storing unit 32, the third storing unit 33, and the fourth storing unit 34 are recycle boxes.

The fifth storing unit 35 stores the banknotes not stored in the first storing unit 31, the second storing unit 32, the third storing unit 33, and the fourth storing unit 34. The fifth storing unit 35 also stores the banknotes collected from the banknote handling apparatus 1. The fifth storing unit 35 may be hereinafter referred to as a “collection cassette.” In the banknote handling apparatus 1, the fifth storing unit 35 does not feed out banknotes.

The banknote handling apparatus 1 includes a transport unit 4. In the banknote handling apparatus 1, the transport unit 4 transports banknotes one by one where those banknotes are spaced apart. The transport unit 4 includes a transport path. The transport path may be a combination of a plurality of rollers, a plurality of belts, a motor for driving them, and a plurality of guides. The transport unit 4 transports the banknotes with their long edges facing forward. The transport unit 4 may transport the banknotes with their short edges facing forward.

The transport unit 4 includes the upper transport unit 41 and a lower transport unit 42. The upper transport unit 41 is located in the handling housing 11. The lower transport unit 42 is located in the safe housing 13. The upper transport unit 41 and the lower transport unit 42 are connected together via an upper wall forming part of the safe housing 13.

The upper transport unit 41 includes an endless loop transport path. The upper transport unit 41 transports banknotes along the loop transport path in each of the clockwise direction and the counterclockwise direction in FIG. 1.

The upper transport unit 41 also includes a plurality of diversion paths diverging from the loop transport path. The plurality of diversion paths connect the loop transport path with the depositing unit 21, the loop transport path with the dispensing unit 22, the loop transport path with the reject unit 23, and the loop transport path with the temporary storage unit 24. A diverter for switching the destination of banknotes is provided at a position where the loop transport path and the diversion path are connected together.

The lower transport unit 42 includes a plurality of transport paths connected to the loop transport path. The plurality of transport paths are connected to the first storing unit 31, the second storing unit 32, the third storing unit 33, and the first storage region 341 of the fourth storing unit 34, the second storage region 342 of the fourth storing unit 34, and the fifth storing unit 35.

As shown in FIG. 2, the banknote handling apparatus 1 includes a controller 15. The controller 15 is an example of the control unit. The controller 15 may include a central processing unit (CPU), a memory, and an I/O circuit. The CPU executes programs. The memory stores programs and data for operating the banknote handling apparatus 1. The memory is a random access memory (RAM) and/or a read only memory (ROM), for example. The I/O circuit performs input and output of an electric signal between the controller 15 and each device connected to the controller 15. The controller 15 is connected with the depositing unit 21, the dispensing unit 22, the reject unit 23, the temporary storage unit 24, the recognition unit 25, the transport unit 4, the fourth storing unit 31, the second storing unit 32, the third storing unit 33, the fourth storing unit 34, and the fifth storing unit 35, so as to be capable of exchanging signals with each other.

The banknote handling apparatus 1 includes a user interface (UI) unit 26, a memory unit 27, and a communication unit 28. The UI unit 26 is a portion that is operated by the user and that provides information to the user. The UI unit 26 may be a touch panel display device, for example. The memory unit 27 stores various types of data or the like. The memory unit 27 is a nonvolatile storage device, for example. The communication unit 28 communicates with an external terminal. The UI unit 26, the memory unit 27, and the communication unit 28 are also connected with the controller 15 so as to be capable of exchanging signals with each other.

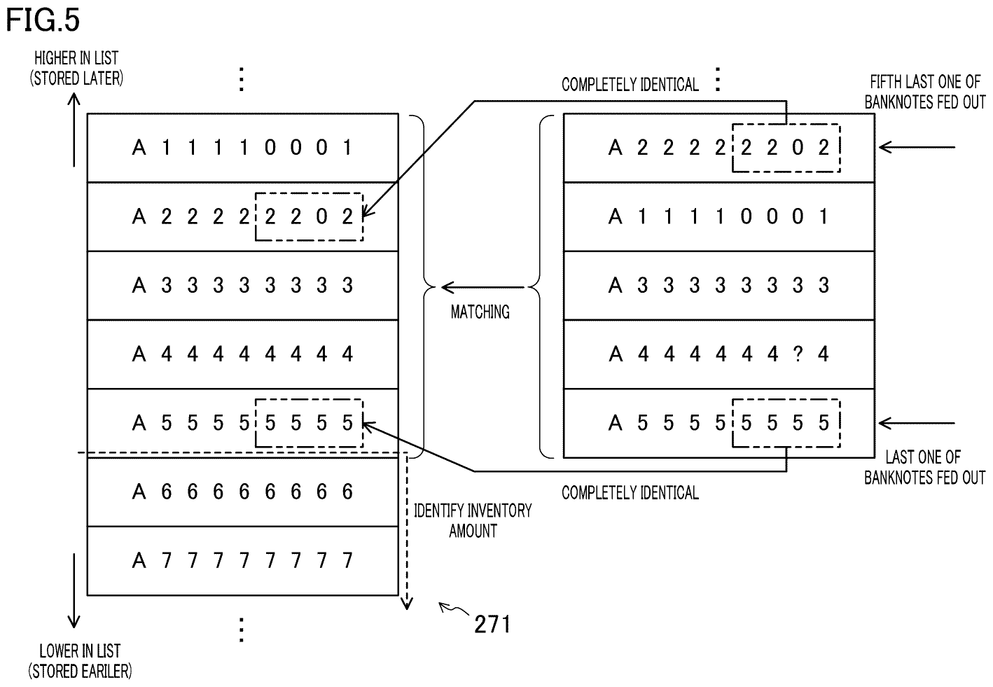

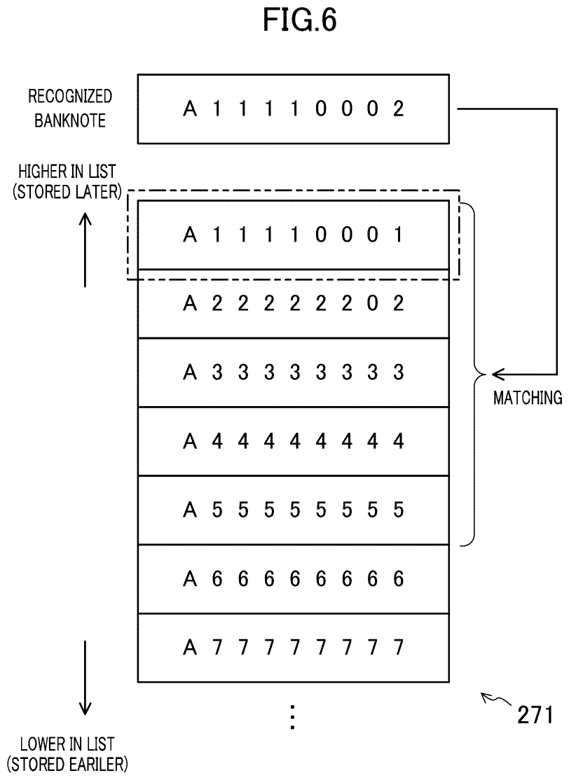

The memory unit 27 stores more detailed information on the banknotes stored in the first storing unit 31, the second storing unit 32, the third storing unit 33, the fourth storing unit 34, and the fifth storing unit 35. The memory unit 27 stores the number, denomination, and total amount of banknotes stored in the storing units 31 to 35. The memory unit 27 also stores the serial numbers of the banknotes stored in the storing units 31 to 35, where those serial numbers are stored in order of the banknotes being stored in the storing units 31 to 35. The information containing the sequence and serial numbers of the banknotes stored therein, where the sequence and the serial numbers are associated together, is hereinafter referred to as the “serial number list 271” in some cases (see FIG. 5 or FIG. 6). The serial number list 271 enables strict management of the banknotes stored in the storing units 31 to 35.

The controller 15 controls the depositing unit 21, the dispensing unit 22, the reject unit 23, the temporary storage unit 24, the recognition unit 25, the transport unit 4, the first storing unit 31, the second storing unit 32, the third storing unit 33, the fourth storing unit 34, and the fifth storing unit 35, in order to execute the process corresponding to the operation of the UI unit 26 performed by the user. It will be described below how the banknote handling apparatus 1 performs the depositing process and the dispensing process.

### (Depositing Process)

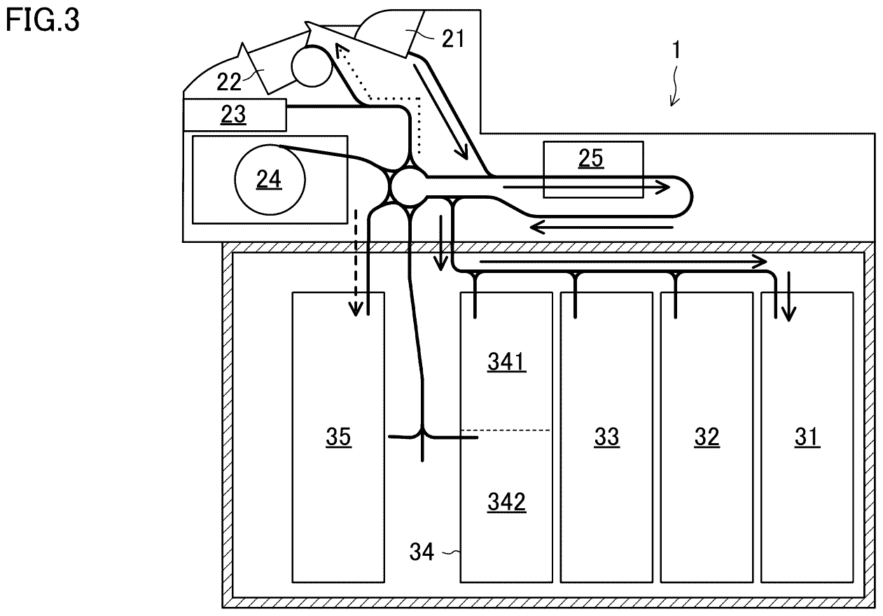

FIG. 3 shows an exemplary transport route of banknotes in the depositing process. The user selecting the deposit transaction inserts the banknotes for deposit into the depositing unit 21. As indicated by the solid arrows in FIG. 3, the depositing unit 21 feeds out the banknotes into the apparatus one by one. The transport unit 4 transports the banknotes to the recognition unit 25. The recognition unit 25 recognizes the banknotes. The recognition unit 25 also recognizes the serial number of the banknote. The recognition unit 25 is permitted to fail to recognize some characters of the serial number, where the number of those characters is less than or equal to a predetermined number n. Specifically, if the number of characters that the recognition unit 25 fails to recognize is the predetermined number n or less, the controller 15 judges that the recognition unit 25 successfully recognizes the serial number. By permitting failure to recognize some of the characters, the handling efficiency of the banknote handling apparatus 1 can be improved. If the number of characters that the recognition unit 25 fails to recognize exceeds the predetermined number n, the controller 15 judges that the recognition unit 25 fails to recognize the serial number. The banknote of which the serial number fails to be recognized is judged as a rejected banknote.

The predetermined number n may be set to any number. The predetermined number n may be set based on the recognition capability of the recognition unit 25. The recognition unit 25 including the CPU may set the predetermined number n by itself based on the self-diagnosis, or the user may manually set the predetermined number n. If the recognition capability of the recognition unit 25 is high, the predetermined number n may be set small. The handling efficiency is not lowered, while accurate management of the banknotes using the serial numbers can be achieved. If the recognition capability of the recognition unit 25 is low, the predetermined number n may be set large. The handling efficiency is less lowered, while accurate management of the banknotes using the serial numbers can be still achieved. In this time, n=3 is employed.

According to the recognition result of the recognition unit 25, the transport unit 4 transports the banknote to the first storing unit 31, the second storing unit 32, the third storing unit 33, the first storage region 341 of the fourth storing unit 34, the second storage region 342 of the fourth storing unit 34, or the fifth storing unit 35. The first storing unit 31, the second storing unit 32, the third storing unit 33, and the first storage region 341 of the fourth storing unit 34, or the second storage region 342 of the fourth storing unit 34 stores the banknote according to the denomination. The fifth storing unit 35 stores the banknotes not stored in the first storing unit 31, the second storing unit 32, the third storing unit 33, and the fourth storing unit 34. In FIG. 3, the transport unit 4 transports the banknote to the first storing unit 31, and the first storing unit 31 stores the banknote. The transport unit 4 transports the banknote judged as the rejected banknote to the dispensing unit 22 as indicated by the dotted arrow. The rejected banknote is returned to the user. The user reinserts the returned banknote into the depositing unit 21, as necessary. When all the banknotes inserted into the depositing unit 21 are taken into the banknote handling apparatus 1, the depositing process ends.

The controller 15 instructs the memory unit 27 to store the data on the banknotes stored in the storing units 31 to 35. For each of the storing units 31 to 35, the memory unit 27 stores the serial numbers recognized by the recognition unit 25, where those serial numbers are stored in order of the banknotes being stored. That is, the memory unit 27 stores the serial number list 271 (see the left part of FIG. 5 or FIG. 6). Every time the depositing process is performed, the memory unit 27 updates and stores the serial number list 271 of the storing units 31 to 35. The serial number list 271 stored in the memory unit 27 reflects the latest storage status of the storing units 31 to 35. The controller 15 can identify the inventory amount of the storing units 31 to 35 based on the serial number list 271 of the storing units 31 to 35.

### (Dispensing Process)

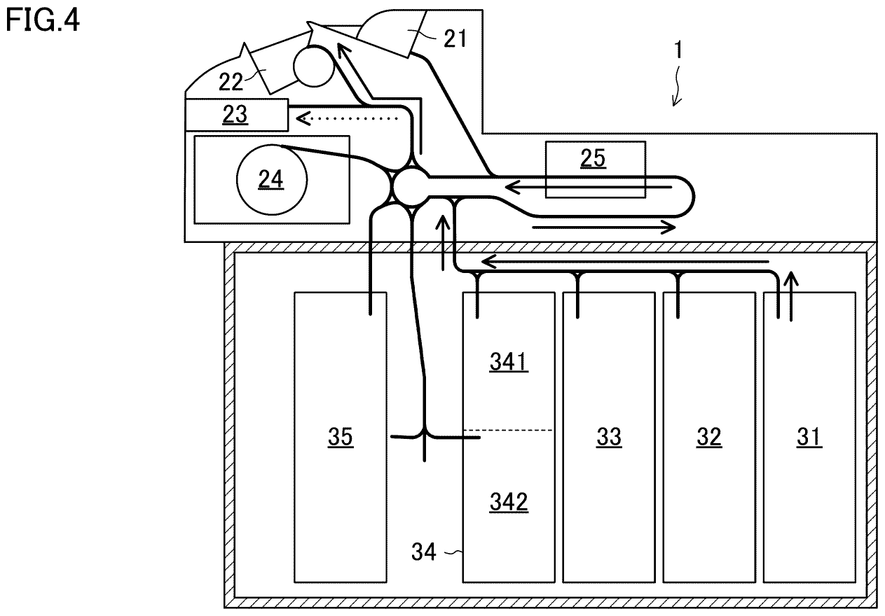

FIG. 4 shows an exemplary transport route of banknotes in the dispensing process. If the user selects the dispensing transaction, the first storing unit 31, the second storing unit 32, the third storing unit 33, the first storage region 341 of the fourth storing unit 34, or the second storage region 342 of the fourth storing unit 34 feeds out dispensed banknotes as indicated by the solid arrows in FIG. 4. The transport unit 4 transports the banknote to the recognition unit 25. The recognition unit 25 recognizes the banknote. The transport unit 4 transports the recognized banknote to the dispensing unit 22. The dispensing unit 22 holds banknote. The transport unit 4 transports the banknote recognized as the rejected banknote by the recognition unit 25 to the reject unit 23 (see the dotted arrow in FIG. 4). The reject unit 23 holds the rejected banknote. When all the banknotes to be dispensed are dispensed to the dispensing unit 22, the dispensing process ends.

### (Matching Process of Dispensing Process)

In the dispensing process, the controller 15 matches the serial number of the banknote with the serial number list 271, where that banknote is a banknote fed out from the storing units 31 to 34 and where that serial number is a serial number recognized by the recognition unit 25.

Based on the matching result of the serial number, the controller 15 identifies the inventory amount of the storing units 31 to 34 left after the dispensing process ends.

FIG. 5 illustrates the matching process of the dispensing process. In the same way as described above, the recognition unit 25 is permitted to fail to recognize some characters of the serial number, where the number of those characters is less than or equal to the number n. In the same way as described above, n=3 may be employed. The right part of FIG. 5 shows the serial numbers of the banknotes fed out from the storing units 31 to 34 in the dispensing process, where those serial numbers are serial numbers recognized by the recognition unit 25. The symbol “?” in the serial number “A444444?4” represents a character that fails to be recognized.

If matching the recognized serial number with the serial number list 271 shows that the number of characters that disagree therebetween is three or less, the controller 15 judges that the recognized serial number is identical to the serial number in the serial number list 271. FIG. 5 shows the example where the controller 15 judges that the recognized serial number “A444444?4” is identical to the serial number “A44444444” in the serial number list 271. Permitting failure to recognize some characters or permitting disagreement on some characters in the matching process of the dispensing process enables the banknote handling apparatus 1 to achieve both the improvement in the handling efficiency and the maintenance of the accurate management of the banknotes.

The storing units 31 to 34 are stack-type storing units, where in some cases the sequence of the banknotes being stored in the storing units 31 to 34 switches from the sequence of the banknotes being transported to the storing units 31 to 34. The serial number list 271 is created according to the sequence of the banknotes passing through the recognition unit 25, and thus, if the sequence of the banknotes being stored switches, the sequence of the banknotes in the serial number list 271 and the sequence of the banknotes actually stored in the storing units 31 to 34 disagree with each other. Thus, even if, in the dispensing process, the serial number of the last one of the banknote fed out from the storing units 31 to 34 is merely matched with the serial number list 271, the banknotes stored in the storing units 31 to 34 left after the dispensing process ends cannot be accurately identified if the position of the last banknote in the sequence of the banknotes stored is different from the position of the same banknote in the serial number list 271.

In order to more accurately identify the inventory amount in the storing units 31 to 34 left after the dispensing process ends, the controller 15 performs matching of the serial numbers of the group of the plurality of grouped banknotes in the matching process of the serial numbers performed in the dispensing process.

Specifically, the controller 15 matches the serial numbers of the m consecutive banknotes fed out from the storing units 31 to 34 with the serial numbers in the serial number list 271, where the m consecutive banknotes include the last one of the banknotes fed out. Here, the number m can be set to any number. The number m of banknotes constituting the group may be determined based on the maximum number of banknotes of which the sequence might change when those banknotes are stored in the storing units 31 to 34. In this time, m=5 is employed.

In the matching process of the dispensing process, the controller 15 judges whether the serial numbers agree with each other according to the following criteria (1) and (2).
(1) If three or less of the characters disagree but the rest of the characters agree between the serial number recognized and the serial number in the serial number list 271, these serial numbers are judged as identical to each other.
(2) In addition to the criterion (1), if the last four characters of the serial number of each of the last one of and the fifth last one of the banknotes fed out from the storing units 31 to 34 are completely identical to the characters of the serial number in the serial number list 271, these serial numbers are judged as identical to each other.

In FIG. 5, according to the criterion (1), the serial numbers recognized, “A11110001,” “A33333333,” and “A444444?4” are judged as identical to the serial numbers in the serial number list 271, “A11110001,” “A33333333,” and “A44444444,” respectively.

In FIG. 5, according to the criterion (2), “A55555555” of the last one of the banknotes fed out is judged as identical to “A55555555” in the serial number list 271; and also according to the criterion (2), “A22222202” of the fifth last one of the banknotes fed out is judged as identical to “A22222202” in the serial number list 271.

When matching is performed between the groups each consisting of the serial numbers of the plurality of banknotes, the sequence of the recognized serial numbers shown in the right part of FIG. 5 and the sequence of the serial numbers in the serial number list 271 shown in the left part of FIG. 5 do not have to agree with each other. This is because, as described above, the sequence of the banknotes in the serial number list 271 might be different from the sequence of the banknotes actually stored in the storing units 31 to 34.

In this manner, the group that belongs to the serial number list 271 and that corresponds to the group of the serial numbers of the five banknotes fed out from the storing units 31 to 34 is determined. In the serial number list 271, this group indicates the boundary between the banknotes fed out from the storing units 31 to 34 and the banknotes stored in the storing units 31 to 34. Based on the serial number list 271, the controller 15 can identify the banknotes stored in the storing units 31 to 34. By performing matching of the group including the plurality of banknotes, the controller 15 can accurately identify the banknotes stored in the storing units 31 to 34 after the dispensing process ends even if the sequence of the banknotes stored switches.

### (Banknote Storage in Depositing Process)

If, as described above, the recognition by the recognition unit 25 permits failure to recognize some characters, and also matching of the serial numbers permits disagreement on some characters, less accurate matching between the serial number recognized and the serial number stored might be performed. An example of this case is that matching of a plurality of consecutive serial numbers is performed. This is because: the number of different characters among the plurality of consecutive serial numbers is one or two; and thus, if the banknote handling apparatus 1 permits failure to recognize some characters or permits disagreement on some characters, all the plurality of similar serial numbers are judged as identical to each other in the process of matching the serial numbers. If the serial numbers are misjudged in the matching process of the dispensing process described above, the controller 15 might incorrectly identify the inventory amount in the storing units 31 to 34. This misjudgement is not limited to the plurality of serial numbers that are consecutive.

The banknote handling apparatus 1 stores banknotes in the depositing process in a considered manner in order to reduce misjudgements of the serial numbers in the matching process of the dispensing process. Specifically, in the depositing process, the controller 15 matches the serial number of a banknote recognized by the recognition unit 25 with the serial number of another banknote recognized earlier than the prior banknote, and then changes the storing unit in which the banknote is to be stored so that the banknotes with the serial numbers similar to each other are not stored in the same storing unit.

FIG. 6 illustrates the matching process of the serial numbers in the depositing process. As described above, the recognition unit 25 recognizes the denomination and the like of the banknote and also recognizes the serial number of the banknote, where this banknote is fed from the depositing unit 21 to the inside of the banknote handling apparatus 1 in the depositing process. The banknotes of the same denomination are basically stored in the same storing among the storing units 31 to 34. FIG. 6 shows an example of the serial number list 271 of a certain storing unit. The serial number list 271 contains not only the serial numbers of the banknotes stored in that storing unit but also the serial numbers of the banknotes being transported to be stored in that storing unit. Thus, matching of the recognized serial number with the serial number list 271, which will be described later, corresponds to matching between the serial number of the banknote recognized by the recognition unit 25 and the serial number of the banknote recognized earlier than the recognized banknote.

Here, assume that, as shown in FIG. 6, the banknote with the serial number “A11110002” is newly stored in the storing unit based on the recognition result of the recognition unit 25. The controller 15 matches the recognized serial number with the serial number list 271. At this time, the controller 15 regards the serial numbers of the m banknotes in the higher positions of the serial number list 271 as matching targets. The m banknotes in the higher positions of the serial number list 271 are the banknotes stored later in the storing unit and continuous with the banknote with the serial number “A11110002” that is to be stored in the storing unit. In this time, m=5 is employed. The number m may be identical to the number m of banknotes constituting the group in the matching process of the dispensing process described above.

In the matching process of the serial numbers in the depositing process, the controller 15 judges whether the serial numbers are similar to each other according to the criterion (1) described above. That is, if n or less of the characters disagree but the rest of the characters agree between the serial number recognized and the serial number in the serial number list 271, these serial numbers are judged as similar to each other. The number n may be identical to the number n for recognition in the depositing process or in the dispensing process. In this time, n=3 is employed. FIG. 6 shows the example where the serial number “A11110001” at the top of the serial number list 271 is judged as similar to the serial number “A11110002.”

If the storing unit stores a plurality of banknotes with similar serial numbers, the misjudgement of the banknote might be made in the matching process of the dispensing process. To address this problem, if the banknotes with similar serial numbers have already been stored in the storing unit, the banknote handling apparatus 1 transports the banknote that is to be stored to another storing unit.

Here, the banknote handling apparatus 1 transports the banknote to the fifth storing unit 35, and the fifth storing unit 35 stores the banknote (see the dashed arrow in FIG. 3). As a result, the plurality of banknotes with similar serial numbers are prevented from being stored in one single storing unit. The serial numbers of the five consecutive banknotes in the serial number list 271 are not similar to one another. Even if failure to recognize three characters is permitted or disagreement on three characters is permitted when matching of the serial numbers is performed in the dispensing process, the misjudgements by the controller 15 can be reduced. The banknote handling apparatus 1 can accurately identify the inventory amount in the storing unit left after the dispensing process, and thus can achieve appropriate banknote handling.

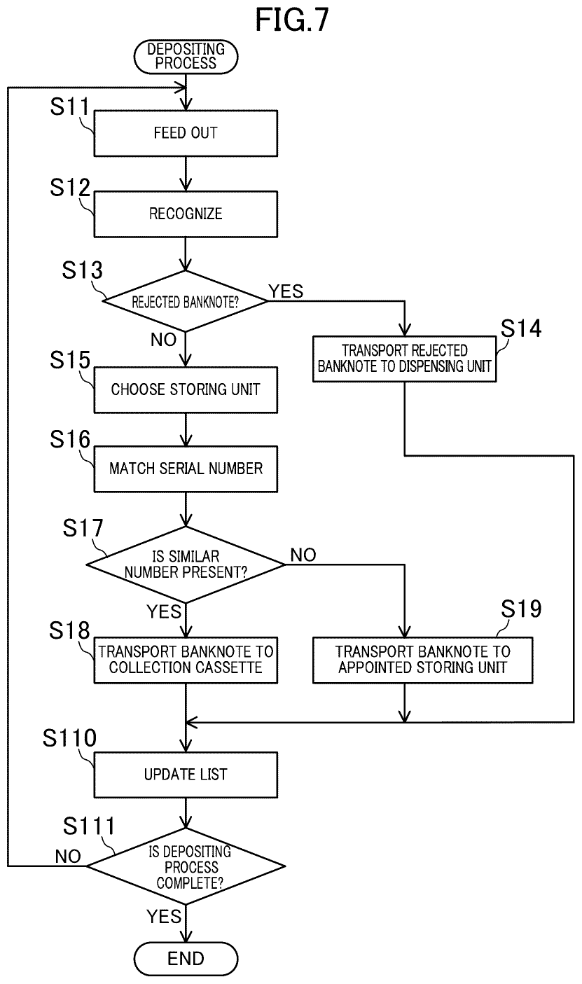

FIG. 7 shows a flowchart of the depositing process. The flowchart in FIG. 7 is executed by the controller 15. In step S11 after the start, the controller 15 instructs the depositing unit 21 to feed out a banknote. Subsequently, in step S12, the controller 15 instructs the recognition unit 25 to recognize the banknote. In step S13, the controller 15 judges whether the banknote is a rejected banknote based on the recognition result of step S12. If the banknote is a rejected banknote, the controller 15 proceeds to in step S14 and instructs the transport unit 4 to transport the rejected banknote to the dispensing unit 22. The rejected banknote is returned to the user through the dispensing unit 22.

If the banknote is not a rejected banknote in step S13, the controller 15 proceeds to step S15 and chooses a storing unit in which the banknote is to be stored based on the denomination of the banknote. Subsequently, in step S16, the controller 15 matches the recognized serial number with the serial number list 271 (see FIG. 6). Then, in step S17, the controller 15 judges whether a serial number similar to the recognized serial number is found in the top five serial numbers in the serial number list 271.

If a similar serial number is found in step S17, the controller 15 proceeds to step S18 and instructs the transport unit 4 to transport the banknote to the collection cassette, i.e., to the fifth storing unit 35. The fifth storing unit 35 stores the banknote. That is, if a similar serial number is found in step S17, the controller 15 executes the control of step S18 so as to decide to change the destination from the storing unit appointed in step S15 to the collection cassette, and so as to transport the banknote to the newly appointed destination that is the collection cassette i.e., the fifth storing unit 35. If a similar serial number is not found in step S17, the controller 15 proceeds to step S19 and instructs the transport unit 4 to transport the banknote to the storing unit appointed in step S15. The storing unit stores the banknote. Step S15 may be omitted. In this case, the destination may be determined based on the result of step S17.

In step S110, the controller 15 updates the serial number list 271 of the storing units 31 to 35 corresponding to the destinations of banknotes.

Subsequently, in step S111, the controller 15 judges whether the depositing process is completed. If the depositing process is not completed, the process in FIG. 7 returns to step S11, and the controller 15 instructs the depositing unit 21 to continue feeding out a banknote. If the depositing process is completed, the process in FIG. 7 ends.

### Variation

The banknote handling apparatus 1 may store the banknotes of the same denomination in the plurality of storing units 31 to 34, e.g., in the first storing unit 31 and the second storing unit 32 as recycle boxes separately. In this case, the banknote handling apparatus 1 may transport the banknotes to the second storing unit 32 instead of the collection cassette in step S18 of the flowchart, and may transport the banknotes to the first storing unit 31 in step S19.

In step S18 of the flowchart, the banknote handling apparatus 1 may transport a banknote to the dispensing unit 22 instead of the collection cassette. In this case, the banknote handling apparatus 1 may notify the user through the UI unit 26 to reinsert the banknote to the depositing unit 21, where the banknote is a banknote having been dispensed to the dispensing unit 22.

The depositing unit 21 feeds the reinserted banknote to the inside of the apparatus again. The recognition unit 25 recognizes the serial number of the reinserted banknote, and the controller 15 matches the recognized serial number with the serial number list 271. The serial numbers in the higher positions of the serial number list 271 at this timing may be different from the serial numbers in the higher positions of the serial number list 271 at the timing when matching of the banknote was initially performed. This is because while the banknote is dispensed to the dispensing unit 22, another banknote that is different from the banknote dispensed to the dispensing unit 22 and that has a serial number not similar thereto is stored in the storing units 31 to 34.

Thus, if the serial number of the reinserted banknote is not similar to the serial numbers in the higher positions of the serial number list 271, the reinserted banknote may be stored in the storing units 31 to 34 in which the banknote was initially unable to be stored. In this case, the plurality of banknotes with similar serial numbers are stored in the same storing unit among the storing units 31 to 34, and the plurality of banknotes with similar serial numbers are not stored close to each other in the storing units 31 to 34. As a result, when matching is performed in the dispensing process, the plurality of banknotes with similar serial numbers are not included in the group consisting of m banknotes, and thus the misjudgements are reduced.

The controller 15 may allocate the banknote reinserted into the depositing unit 21 to the transaction related to the banknote initially fed from the depositing unit 21 to the inside of the apparatus. Since the reinserted banknote is managed as a banknote related to one transaction, the banknote handling becomes appropriate.

In the foregoing description, the depositing process from steps S11 to S111 is performed to improve the accuracy of matching of the serial numbers of the banknotes to be dispensed in the dispensing process, but the depositing process from steps S11 to S111 can be performed to improve the accuracy of the reconciliation process where the information on the serial numbers is used to identify the inventory amount of the banknotes stored in the storing units.

The banknote handling apparatus to which the banknote handling method disclosed herein is applicable is not limited to the banknote handling apparatuses 1 and 100 described above. The banknote handling method disclosed herein is applicable to banknote handling apparatuses having various structures.

The functionality of the elements disclosed herein may be implemented using circuitry or processing circuitry which includes general purpose processors, special purpose processors, integrated circuits, ASICs (“Application Specific Integrated Circuits”), conventional circuitry and/or combinations thereof which are configured or programmed to perform the disclosed functionality. Processors are considered processing circuitry or circuitry as they include transistors and other circuitry therein. The processor may be a programmed processor which executes a program stored in a memory. In the disclosure, the circuitry, units, or means are hardware that carry out or are programmed to perform the recited functionality. The hardware may be any hardware disclosed herein or otherwise known which is programmed or configured to carry out the recited functionality. When the hardware is a processor which may be considered a type of circuitry, the circuitry, means, or units are a combination of hardware and software, the software being used to configure the hardware and/or processor.

What is claimed is:

1. A banknote handling method comprising:
sequentially feeding banknotes from an inlet to an inside of an apparatus;
sequentially recognizing the banknotes fed to the inside of the apparatus using a recognition circuit;
transporting a first banknote to a first storage for a first denomination by a conveyor and storing the first banknote in the first storage, wherein the recognition circuit recognizes that the first banknote is a banknote of the first denomination and has a first serial number; and
after recognizing the first banknote by the recognition circuit, transporting a second banknote to a second storage by the conveyor based on a comparison between the first serial number and a second serial number performed by a controller, wherein the recognition circuit recognizes that the second banknote is a banknote of the first denomination and has the second serial number.

2. The method of claim 1, wherein
the controller determines whether the first serial number and the second serial number are similar,
if the first serial number and the second serial number are similar, the second banknote is transported to the second storage by the conveyor, and
if the first serial number and the second serial number are not similar, the second banknote is transported to the first storage by the conveyor, and is stored in the first storage.

3. The method of claim 2, wherein
the controller determines that the first serial number and the second serial number are similar if matching the first serial number with the second serial number both recognized by the recognition circuit shows that the number of characters that disagree therebetween is less than or equal to a predetermined number n.

4. The method of claim 3, further comprising:
storing, by a memory, a serial number of the banknote stored in the first storage;
in a dispensing process of the apparatus, feeding out a banknote stored in the first storage as a banknote for dispensing; and
recognizing, by the recognition circuit, the banknote which the first storage feeds out in the dispensing process, and matching, by the controller, the serial number recognized with the stored serial number, wherein
the controller determines that the serial number recognized and the stored serial number are identical if the number of characters that disagree between the serial number recognized and the stored serial number is less than or equal to the predetermined number n.

5. The method of claim 3, wherein
the predetermined number n is changeable.

6. The method of claim 5, wherein
the predetermined number n is set based on a recognition capability of the recognition circuit.

7. The method of claim 2, wherein
the controller compares the second serial number with each serial number, wherein a banknote corresponding to each serial number is included in a group consisting of continuous m banknotes immediately prior to the second banknote among banknotes recognized as banknotes of the first denomination and stored in the first storage before the second banknote is recognized by the recognition circuit, and
if a serial number similar to the second serial number is included in the group, the conveyor transports the second banknote to the second storage.

8. The method of claim 7, wherein
the number m of the banknotes is changeable.

9. The method of claim 1, wherein
the first storage stores the banknotes in a stacked manner.

10. The method of claim 1, wherein
in the dispensing process of the apparatus, the second storage does not feed out a banknote stored in the second storage as a banknote for dispensing.

11. The method of claim 10, wherein
the first storage and the second storage are housed in a safe.

12. The method of claim 1, wherein
the second storage is an outlet that dispenses the second banknote to an outside of the apparatus.

13. The method of claim 12, further comprising:
making a notification to propose reinserting the second banknote to the inlet, wherein the second banknote is a banknote having been dispensed to the outlet, and
transporting the second banknote to the first storage by the conveyor and storing in the first storage if the second serial number of the second banknote fed again from the inlet to the inside of the apparatus is not similar to serial numbers of m banknotes most recently stored in the first storage.

14. The method of claim 13, wherein
the controller allocates the second banknote reinserted into the inlet to a transaction related to the banknote initially fed from the inlet to the inside of the apparatus.

15. The method of claim 1, further comprising:
deciding, by the controller, to transport the second banknote to the first storage for the first denomination by the conveyor, wherein the recognition circuit recognizes that the second banknote is a banknote of the first denomination and has the second serial number; and
then, transporting, by the conveyor, the second banknote to the second storage by changing a destination of the second banknote from the first storage to the second storage, based on the comparison between the first serial number and the second serial number performed by the controller.
